(19) United States
(12) Patent Application Publication
(10) Pub. No.: US 2002/0133611 A1
(43) Pub. Date: Sep. 19, 2002

(54) System and method for facilitating real-time, multi-point communications over an electronic network

(76) Inventors: Eddy Gorsuch, Fremont, CA (US); Sophie Muller, Palo Alto, CA (US); James A. Savage III, San Jose, CA (US)

Correspondence Address: COOLEY GODWARD LLP, Attention: Patent Group, Five Palo Alto Square, 3000 El Camino Real, Palo Alto, CA, 94306, US

(21) Appl. No.: 09/811,102

(22) Filed: Mar. 16, 2001

(51) Int. Cl. G06F 15/16

(52) U.S. Cl. 709/231; 709/205

(57) ABSTRACT

A method and system are provided for receiving communications requests over an electronic network and using a dispatch server to direct the communications requests to a media server that establishes a conference and processes communications thereof. Dispatch servers may select a media server from a plurality of media servers by consulting available capacity data for the media servers.

1. Field of Invention

The present invention relates to systems and methods that provide real-time, multi-point communications over an electronic network. Specifically, embodiments of the invention provide real-time communications to clients using servers configured to host client conferences, wherein a server is selected for a given conference based upon the server's available capacity.

2. Background of the Invention

Currently, tremendous amounts of capital and engineering expertise are being applied to the problem of supplying real-time audio and video communication between and among remote locations over the Internet. However, at the present time there are few acceptable solutions for providing the kind of reliable, high quality communications to which consumers have become accustomed, e.g., communication over the dedicated connections of the public telephone infrastructure.

In fact, a significant portion of the problems associated with most Internet telephony applications is directly related to the fact that the link between the two communicating clients is not dedicated. That is, because the connections between the two clients are shared with a variety of other Internet traffic, there is, more often than not, a noticeable degradation in signal quality which results from the unpredictable and erratic traffic conditions of the Internet. The problem is exacerbated by the fact that, even with sophisticated data compression technology, audio and video data require a significant amount of bandwidth. Audio requires roughly 100 times the bandwidth required for text data, and the amount of bandwidth required for video is further orders of magnitude beyond audio.

Many Internet service providers (“ISPs”) and portals as well as entertainment and e-commerce web sites already provide a form of communication among remote clients which attempts to simulate real-time communication and have done so for some time. This form of communication is commonly referred to as a “chat room.” An ISP or portal provides an HTML link to a web page in which users may view text comments from other users and post text comments of their own in response. A chat room is typically implemented by dedicating a portion of a server owned and maintained by the ISP or portal to the handling and transmission of the text comments for all users currently viewing the corresponding page. Another similar form of communication provided by many ISPs and portals is referred to as “instant messaging” in which a user may send a text message to another user currently on-line with the same ISP.

The implementation of text messaging and chat rooms is relatively straightforward and reliable largely due to the fact that text messages require very little bandwidth and that there are no substantial latency issues related to the actual transmission of such messages. That is, due to the nature of text messages, traffic conditions do not result in delay or degradation that is noticeable from the user's perspective. Unfortunately, it is the nature of text communication that makes it so unsatisfactory a medium when compared with real-time audio and/or video communication. That is, communication by text is characterized by long delays in which the communicants must manually type their messages, and because of which messages often cross on the network. This often results in confusing exchanges with one or the other of the users eventually suggesting that the conversation recommence on a more reliable medium, e.g., the phone.

Moreover, the model according to which text communication is currently implemented is not applicable to audio or video communication because of the network traffic issues discussed above. Even if one were able to guarantee quality of service over the Internet, the bandwidth requirements of, for example, an audio chat room would not be amenable to the dedicated server approach currently employed. That is, a single text chat server can scale to thousands, even tens of thousands of users. However, because the bandwidth requirements of audio chat are roughly 100 times greater, a single server could only handle dozens (or at most a few hundred) users simultaneously. This is clearly inadequate given the user traffic of the large ISPs.

To handle its anticipated chat room traffic, a large ISP could employ multiple chat servers, each server being dedicated to running one or more specific chat rooms. However, this approach presents a variety of other problems. First, because an ISP has no way of predicting chat room traffic, it is likely that situations would frequently arise in which, due to the popularity of particular chat rooms, the capacity of the corresponding servers would be exceeded, resulting in dropped packets, the exclusion of new users, or even entire chat rooms going off-line. This could be alleviated by providing sufficient excess capacity on each server, but this would result in an unacceptable inefficiency in the use of server resources.

Another problem with such an approach is that the number of servers required to accommodate audio chat for the chat room traffic of a typical ISP would be quite large. While this may be seen as a great benefit for manufacturers of server hardware, it is not a desirable solution for the ISP from either an economic or administrative viewpoint. Not only would it be expensive for each ISP to purchase and maintain such a large number of servers, it would also increase the odds that specific chat rooms would be inaccessible to users. That is, each time a particular server went down (e.g., for routine maintenance or as a result of a fault) the chat rooms on that server would be inaccessible to users until the server was rebooted or replaced. Understandably, this is undesirable from the ISP's point of view.

It is therefore desirable to provide high quality, real-time communication among a plurality of remote clients using a system which is scaleable to hundreds of thousands, even millions of users, and which dynamically allocates system resources to create and maintain communications among the clients.

### SUMMARY OF THE INVENTION

Embodiments of the invention provide a method and system for providing conference communications to a client of a plurality of clients. Embodiments of the method may comprise receiving a join conference request by a dispatch server from the client over an electronic network, wherein the join conference request identifies a conference requested by the client. The dispatch server transmits an identity of a media server configured to host the conference requested by the client after selecting the media server from a plurality of media servers using data pertaining to available capacity on the media servers. The client may receive conference communications by contacting the identified media server.

Embodiments of the invention also provide a method and system for providing conference communications to a client of a plurality of clients. A media server, configured to provide conference communications, may receive a join conference request from the client over an electronic network. The client has received an address for the media server from a dispatch server that selected the media server from a plurality of media servers based upon available capacity for hosting a conference for the client. The media server sends the client a channel identity, wherein the channel identity informs the client where the media server receives communications data.

Embodiments of the invention further provide a method and system for providing conference communications to a client of a plurality of clients. The client sends a join conference request to a dispatch server over the electronic network, wherein the join conference request identifies a conference requested by the client. The client receives an identity of a media server configured to host the conference requested by the client, wherein the dispatch server has selected the media server from a plurality of media servers using data pertaining to available capacity on the plurality of media servers.

Embodiments of the invention provide a method and system for providing conference communications to a client of a plurality of clients. A dispatch switch receives a first join conference request from the client over an electronic network, wherein the dispatch switch has been configured to select a first dispatch server from a plurality of dispatch servers to receive the join conference request. The first join conference request identifies a conference requested by the client. The first dispatch server transmits to the client an identity of a media server configured to host the conference requested by the client. The first dispatch server has selected the media server from a plurality of media servers using data pertaining to available capacity on the plurality of media servers. The client receives conference communications by contacting the identified media server.

Embodiments of the invention provide a method and system for providing a caller with conference communications. A dispatch server receives a call from the caller over a telephony network. The dispatch server selects a media server of a plurality of media servers to service the call, wherein the media servers of the plurality of media servers are configured to provide conference communications. The dispatch server sends a signal to the selected media server to initiate communications with the dispatch server. The dispatch server receives the communications from the selected media server and connects the call with the communication from the media server.

Embodiments of the invention provide a method and system for inserting a client of a plurality of clients into a conference conducted over an electronic network. A plurality of media servers are each configured to provide conference communications. At least one dispatch server is configured to identify a media server of the plurality of media servers having appropriate capacity for providing conference communications for the client and configured to direct the client to the identified media server.

Embodiments of the invention also provide a dispatch server configured to facilitate conference communications between clients of a plurality of clients. The dispatch server may include a client host service module which is configured to receive a join conference request from the client over an electronic network. The join conference request identifies a conference requested by the client. The dispatch server may include a dispatch service module which is configured to select a media server from a plurality of media servers to host the conference requested by the client using data pertaining to available capacity on the plurality of media servers. The client may receive conference communications by contacting the identified media server.

Embodiments of the invention provide a media server configured to provide conference communications to a client of a plurality of clients. The media server may include a client host service module configured to receive a join conference request from the client over an electronic network. The client has received an address for the media server from a dispatch server that selected the media server from a plurality of media servers based upon available capacity for hosting a conference for the client. The join conference request identifies the conference requested by the client. The media server may also include a connect service module which is configured to arrange conference transmissions for conference participants. The media server may also include mesh service module which is configured to transmit media data to conference participants.

### BRIEF DESCRIPTION OF THE DRAWINGS

An embodiment of the invention will be described below relative to the following figures. Note that similar elements and steps in the figures have the same reference number.

FIG. 1 provides a simplified block diagram illustrating a network operation center (“NOC”) 100, according to an embodiment of the invention.

FIG. 2 is a flow diagram illustrating the addition of a client to a conference, according to an embodiment of the invention.

FIG. 3A illustrates a conference table 300 that matches conferences with their host media servers, according to an embodiment of the invention.

FIG. 3B illustrates a capacity table 301 that identifies media servers, their addresses, states, capabilities, communication statuses, and unused capacities, according to an embodiment of the invention.

FIG. 4 illustrates an embodiment of the invention in which the NOC 100 has been expanded to include an authentication server 106 and a standby dispatch server 110.

FIG. 5 illustrates an embodiment of the invention having multiple active dispatch servers 102a-102c configured for parallel dispatching of client communication requests, according to an embodiment of the invention.

FIG. 6 illustrates a capacity table 601 that identifies media servers, their state, the media type(s) supported, and their capacity, according to an alternate embodiment of the invention.

FIG. 7 provides a simplified block diagram of an authentication server, according to an embodiment of the invention.

FIG. 8 provides a simplified block diagram of a dispatch server, according to an embodiment of the invention.

FIG. 9 provides a simplified block diagram of a media server, according to an embodiment of the invention.

FIGS. 10A-10D illustrate a dispatch server 1000 that has been configured to provide a switchboard function that dispatches incoming communications requests by connecting a client 108, or a customer, to its destination over the public switched telephone network, according to an embodiment of the invention.

FIG. 11 is a representation of a graphical user interface on a client machine, according to an embodiment of the invention.

FIG. 12 is a simplified block diagram of a client plug-in module, according to an embodiment of the invention.

FIG. 13 is a simplified diagram of a network environment, according to an embodiment of the invention.

FIG. 14 is a block diagram of a computer architecture suitable for implementing embodiments of the invention.

### DETAILED DESCRIPTION OF THE ILLUSTRATED EMBODIMENTS OF THE INVENTION

According to embodiments of the invention, a system and method provide high quality, real-time communication among a plurality of remote clients over an electronic network, such as the Internet. An embodiment of the invention provides a conferencing system that may be scaled to any number of simultaneous users and which may be used simultaneously by any number of Internet Service Providers (“ISPs”), portals, and web sites to implement audio and/or video conferences through their sites. The system may be based on a farm of servers, referred to herein as “media servers,” each of which runs one or more conferences in which any number of users may participate. A dispatch server may facilitate dynamic creation and allocation of conferences among the media servers according to their available capacity. The dispatch and media servers (referred to collectively herein as the network operating center or “NOC”) may sit directly on a high bandwidth, optical backbone by which remote clients may access the system, according an embodiment of the invention.

The system's conferencing capacity may be allocated according to agreements with customers (e.g., ISPs, portals, web auction sites, e-commerce sites, etc.) who, in turn, provide access to the system to their subscribers (or users). For example, the ISP may provide a web page that includes embedded graphical objects, selection of which by a subscriber on a client machine initiates the subscriber's participation in a conference. To access the system, a one-time download of a lightweight client, e.g., a browser plug-in, is typically required. Depending upon the configuration, when a user views a conference-enabled web page or when she clicks to join, the browser may transmit the IP address of a dispatch server, the conference name, and an authentication code to the client. The client then contacts the dispatch server and, using the plug-in, transmits a request to join the conference. If the client is validated (e.g., by reference to the authentication code), the dispatch server determines whether the requested conference is currently being facilitated on any of the media servers. If the conference exists, the dispatch server dispatches the client to the corresponding media server. That is, the client is given the IP address of the media server, to which it transmits another join request. The media server then establishes a channel to the client and adds the client to the requested conference.

If, on the other hand, the requested conference does not exist, the dispatch server reviews information retained regarding the available capacity of the media servers for which it has an association. The dispatch server typically determines which media server has the greatest unused capacity and triggers creation of the requested conference on that media server. The client is then dispatched to the media server in the manner described above. As clients leave a conference, the media server deletes them from the conference. When the last client is deleted, the conference is also deleted.

Because dynamic creation and allocation of conferences among the media servers are facilitated by the dispatch server according to media server capacity, the system's resources are efficiently used. Moreover, because the conferences are created dynamically, they may be recreated on another server in the event that, for example, the current server's capacity is exceeded. The shifting of a conference between servers is accomplished transparently without the need for action by the participants.

Hardware and software deployed in dispatch servers may retain state information for the media servers with whom the dispatch server retains an association, according to an embodiment of the invention. That is, once the dispatch server dispatches a client to a media server for participation in a conference, the dispatch server may retain some information about the existence of both the client and the conference. Once there are no clients left in a conference on a media server, the host media server releases the conference and transmits a request to delete the conference from the system's active conference records, according to an embodiment of the invention. Conversely, the client typically “knows” nothing about the structure and operation of the network operating center. It merely receives an address and a confirmation mechanism from the ISP and connects with the system accordingly. The result is an extremely reliable, robust, and flexible architecture which is adaptable to service any level of conference traffic.

The present invention may further provide a system for facilitating communication between a plurality of clients on a network. The system may include a plurality of media servers coupled to the network, each of which is configured to facilitate at least one conference. A dispatch server is coupled to the network for dispatching the clients to the conferences on the media servers based upon the dispatch server's data regarding each media server's available capacity. In response to a request from a client to join a first conference, the dispatch server is operable to determine which of the media servers is facilitating the first conference, or trigger creation of the first conference on one of the media servers.

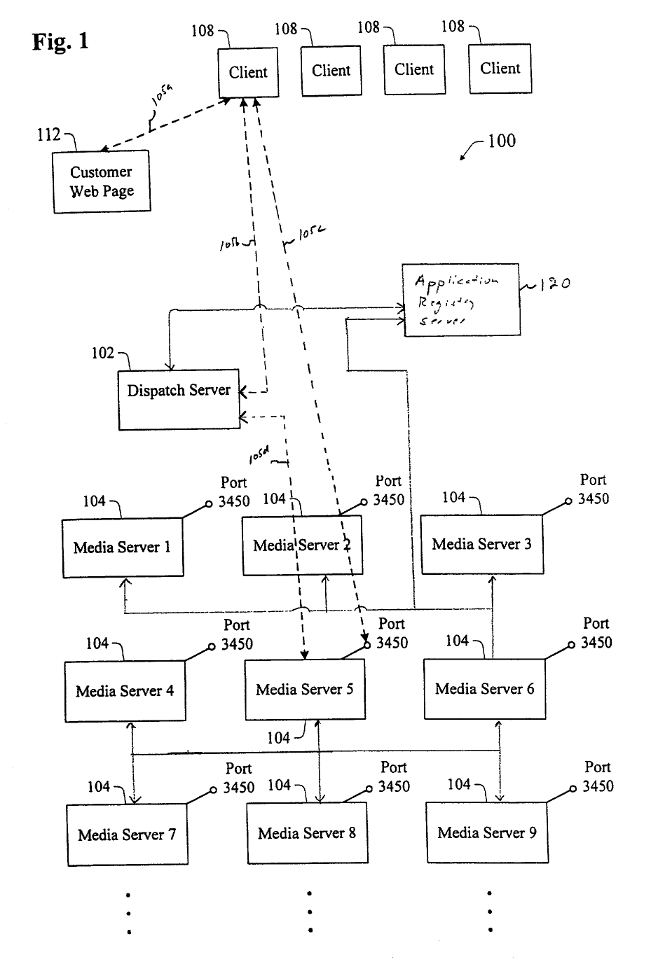

FIG. 1 provides a simplified block diagram illustrating a network operation center (“NOC”) 100, according to an embodiment of the invention. The various elements associated with the NOC 100 reside in and/or communicate via an electronic network, portions of which are shown as communication segments 105a, 105b, 105c, and 105d. The electronic network may be a local area network (“LAN”), a wide area network (“WAN”), and/or the Internet, for example. In an Internet embodiment, the NOC 100 may reside directly on a high bandwidth Internet backbone. A representative high bandwidth Internet backbone is provided by Qwest Communications, Inc. of Denver, Colo.

A dispatch server 102 manages conference requests for a plurality of media servers 104. The media servers 104 provide communications services among clients 108, e.g., between customers associated with client 108 and a client 108 associated with an operator who herself is associated with a customer web page 112. The servers (e.g., the dispatch server 102) employed in various embodiments of the invention may comprise any type of software executable on a computer configured for communications across an electronic network. The dispatch server 102 may be implemented in software on a dedicated server. Alternatively, the dispatch server 102 may be incorporated into a media server 104. As will be discussed in greater detail below, specific server types typically include additional software configured for one or more specialized tasks, such as dispatching incoming communication requests. For example, the dispatch server 102 maintains various software modules for managing the media servers 104 and for coordinating communications with clients 108. The term media server is used herein to signify that the communications facilitated by media servers 104 may comprise any of a variety of media including, for example, audio, video, text, etc.

Each of the servers in the NOC (e.g., the media servers 104 and the dispatch server 102) may include software configured to register with an application registry server 120. When a server (e.g., dispatch server, media server) begins operating in the NOC 100, the new server is typically configured to notify the application registry server 120 (e.g., the application registry server 120 may have a well-known IP address). The notification may include the new server's IP address, its capabilities, and any other information that would be helpful in maximizing the server's usefulness to the NOC 100.

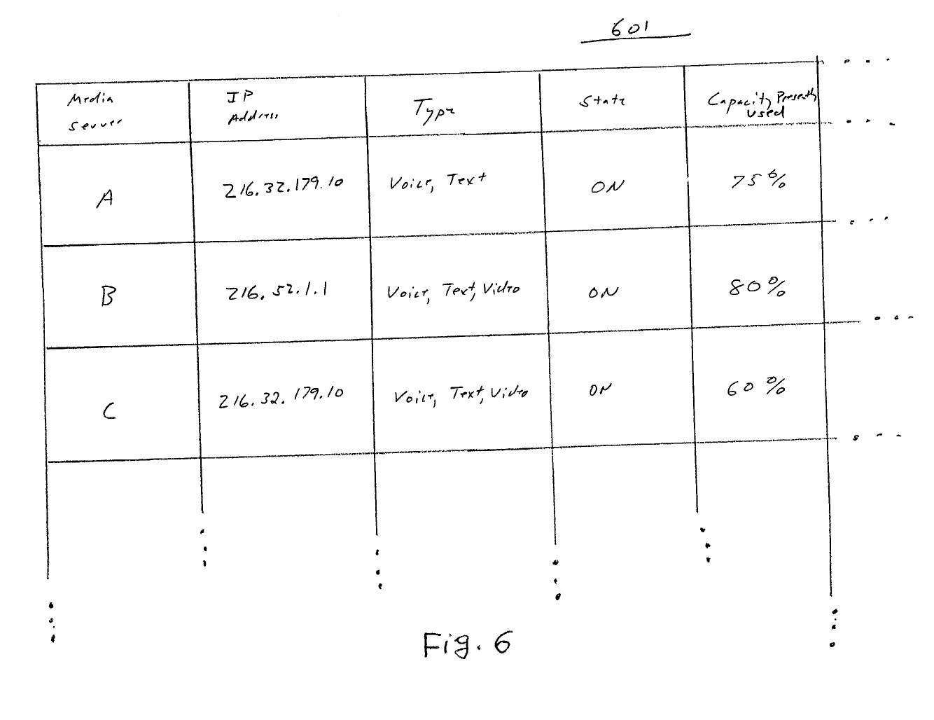

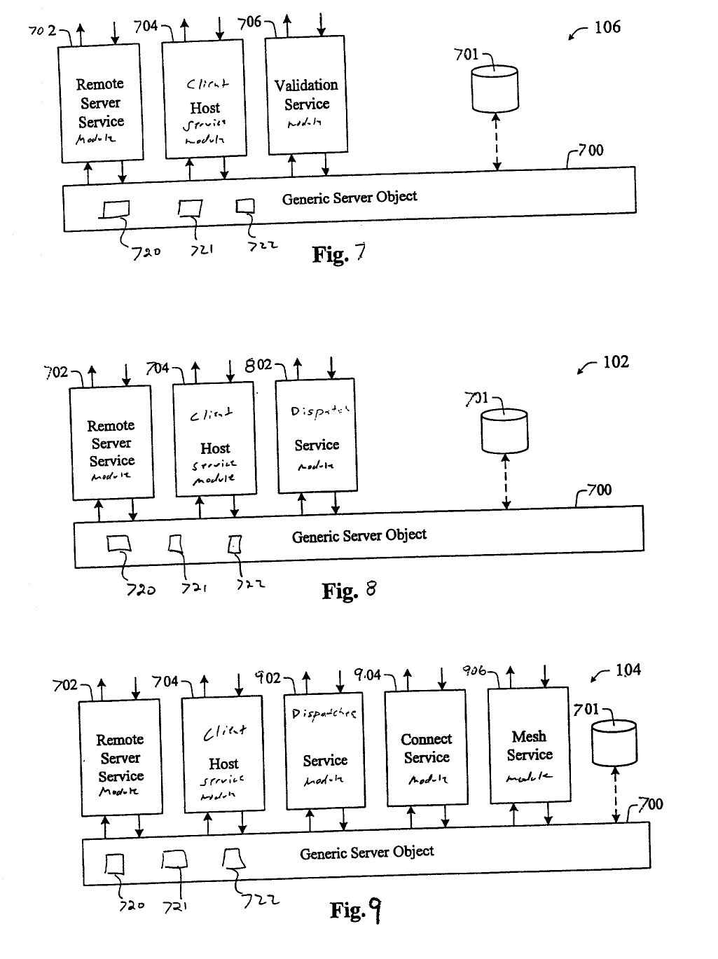

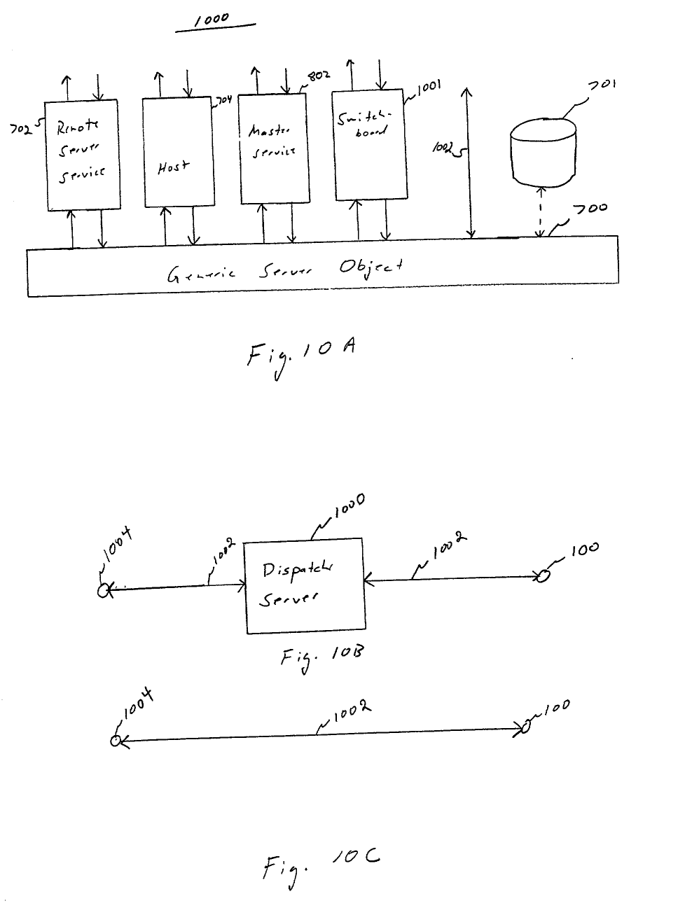

The dispatch server 102 and the media servers 104 may include software configured to “listen” on a port (e.g., port 3450) for clients 108 requesting access to the NOC 100, according to an embodiment of the invention. (FIGS. 7-9 provide a more detailed description of the software configuration employed on the servers, according to an embodiment of the invention.) The client 108 typically comprises software associated with a computer (e.g., a user's personal computer) configured to perform a variety of tasks, including communicating data to the dispatch server 102 and the media servers 104. The media servers 104 may listen for communications from the clients 108 on particular ports, e.g., port 3450.

The dispatch server 102 typically maintains a list of all media servers 104 currently registered with the application registry server 120. The dispatch server 102 may periodically contact the application registry server 120 to obtain a new list of media servers suitable for hosting conferences requested by clients. The list obtained by the dispatch server 102 from the application registry server 102 typically includes the IP addresses of the registered media servers 104 and whether they are currently active. When a media server 104 begins to enter an inactive state, whether planned or unplanned, a software module (e.g., a dispatchee service module 902) on the media server 104 notifies the application registry server 120, which then makes the appropriate change to its server list. The application registry server 120 may also periodically contact its registered servers to determine whether they are still active. The application registry server 120 is shown in FIG. 1 as a separate server. Of course, an ordinary artisan will recognize that its functionality could likely be combined with that of another server type, e.g., the dispatch server 102.

An example of the operation of NOC 100 will now be described with reference to FIGS. 1, 2, 3A, and 3B. The communication segments 105a, 105b, 105c, and 105d, shown as dashed lines in FIG. 1, represent the lines of communication between various devices. A client 108 initially connects with a customer web page 112, such as a web page maintained by a customer of the NOC 100. A user's viewing the web page 112, or clicking on a link in the web page 112, may cause the client 108 to send an indication that the user wishes to participate in a conference, which will be referred to in this example as “conference XYZ.” If client 108 does not have an appropriate plug-in that allows it to communicate with the NOC 100, the plug-in may be quickly downloaded and installed on client 108. Once client 108 has the plug-in, the web page 112 gives the client 108 the IP address of the dispatch server 102 and an account number (or authentication code) which is used for authentication purposes, according to an embodiment of the invention. As will be discussed below, embodiments of the invention may employ an authentication server that screens incoming client communication requests for the dispatch server 102. Of course, the authentication server may also be implemented in the dispatch server.

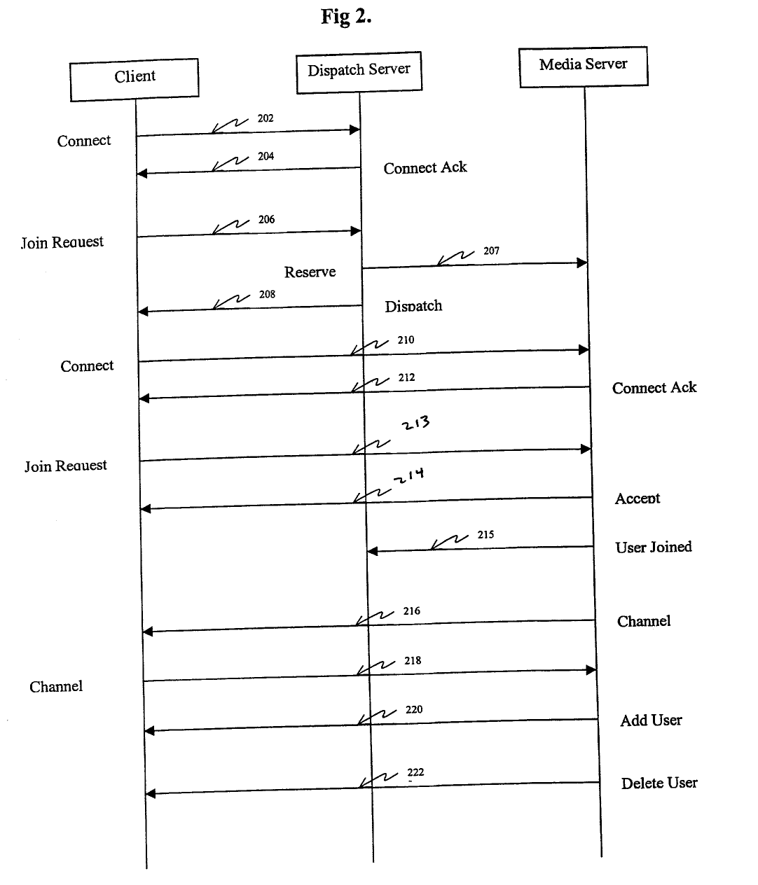

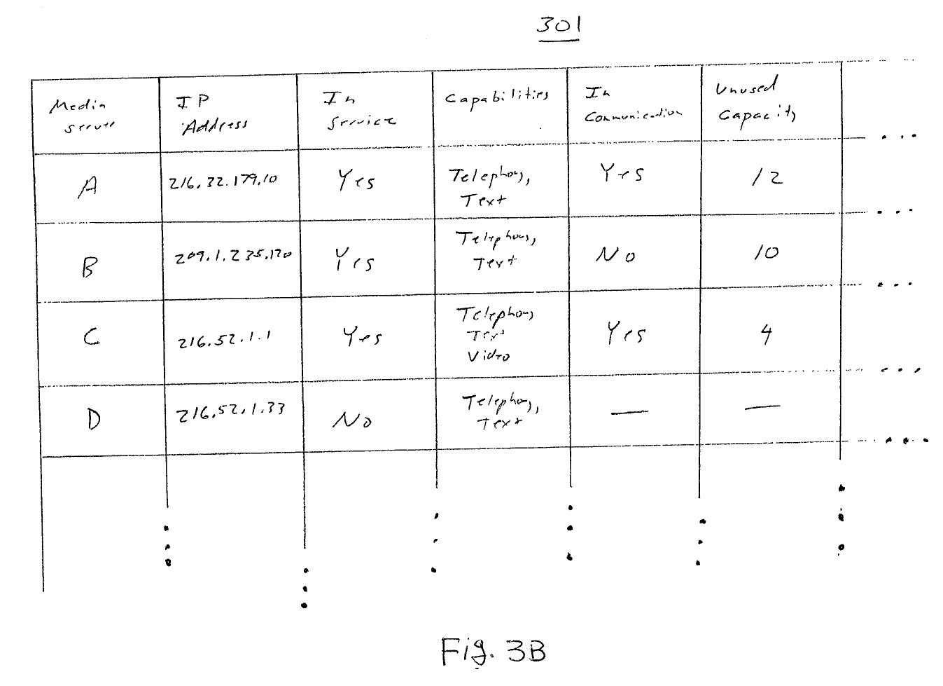

Using the IP address obtained from the web site 112, the client 108 contacts the dispatch server 102 requesting to join conference XYZ. Thus, the client 108 initiates a connect request 202 (as shown in FIG. 2) to the dispatch server 102 using the IP address obtained from customer web page 112, according to an embodiment of the invention. The connection may use any suitable protocol, e.g., a TCP socket. In response to the client connect request 202, the dispatch server 102 transmits a connect acknowledgement 204. The client 108 then sends a join request 206, which contains data that the dispatch server 102 may use to authenticate or validate the client 108. Alternatively, when the first point of contact between the client 108 and the NOC 100 is an authentication server (discussed below in conjunction with FIG. 4), the client 108 and the authentication server typically follow a similar connection procedure.

The dispatch server 102 typically receives the join request 206 from client 108 via a predetermined port (e.g., port 3450) and then validates the request. Validation may be accomplished by comparing the account number or authentication code accompanying the request with a list of valid accounts accessible to dispatch server 102. Alternatively, the request may be preceded by a communication from the customer web site alerting the dispatch server 102 of the impending request and providing authentication information.

Once the connection is established, the client 108 sends a join request 206 with a plurality of parameters to the dispatch server 102. These parameters may include: the conference name, an account number, a user name if known (otherwise, a name may be assigned and/or the user may be prompted to supply a name), web host IP (which may be determined programmatically for validation of origin), operating system, browser, browser version, sound card, sound card driver, and other information helpful in establishing communications. Typically, the client 108 must supply a minimal amount of identifying information, such as a conference name or an account number.

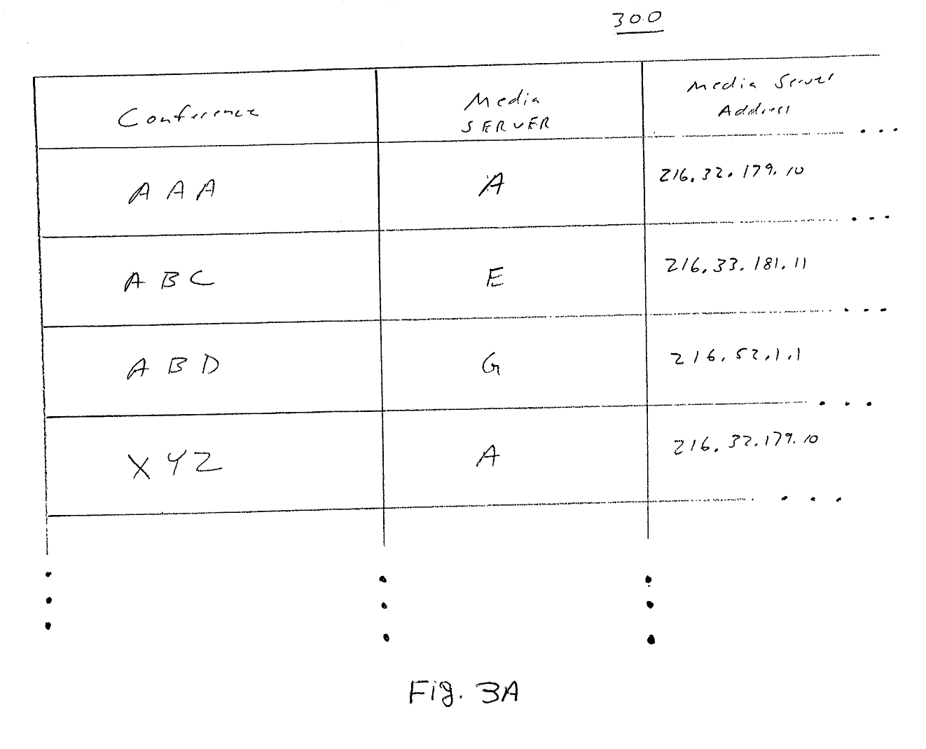

Upon receiving the join request 206 from the client to join conference XYZ, the dispatch server 102 determines whether conference XYZ exists by consulting a conference data repository, such as conference table 300 shown in FIG. 3A, which lists the established conferences in the NOC 100 and the IP address of the media server 104 hosting the conference. The conference table 300 may reside in a cache memory associated with the dispatch server 102, although the conference table 300 could also reside in a data repository located elsewhere. If XYZ conference is running on a particular media server 104 (e.g., Media Server A), the dispatch server 102 transmits a reserve message 207 to the media server which informs the media server that an additional client may soon be added to a conference hosted by the server. The dispatch server 102 may also transmit a dispatch message 208 to the client 108 which includes the IP address of the relevant media server 104. That is, the dispatch server 102 dispatches the client 108 to the IP address of the media server 104 on which conference XYZ is currently being facilitated. This causes the client 108 to disconnect from dispatch server 102 by sending an ENDSESSION message and operating a four-stage classical disconnect (fin, ack, fin, ack), and establishing a connection 210 to Media Server A, e.g., the same type of call that the client used to contact the dispatch server 102.

In response to the connection 210, Media Server A transmits a connection acknowledgment 212 to the client 108. In response to the connect acknowledgement 212, the client 108 transmits a join request 213. Media Server A transmits an accept command 214 that informs the client 108 that the join request 213 has been accepted.

The Media Server A also transmits a user joined command 215 to the dispatch server 102 that informs the dispatch server 102 that a new party has joined a conference hosted on the Media Server A. The media servers typically obtain a list of all registered dispatch servers from the application registry server 120 and multicast information to all the dispatch servers known to it. Accordingly, more than one dispatch server 102 may receive the user joined command 215, depending on the NOC's configuration. The user joined command 215 allows the dispatch server(s) 102 to update the capacity data for each of the Media Servers that may accept conference requests selected by the dispatch server 102. For example, the dispatch server 102 may maintain such information in a capacity data repository, such as a capacity table 301 shown in FIG. 3B, which the dispatch server 102 accordingly updates to indicate that the Media Server A has accepted the client 108. The capacity table 301 assists the dispatch server 102 track the available (e.g., unused) capacity on each of the media servers 104 to which it can direct clients and conferences.

Because conference XYZ is running on Media Server A, Media Server A establishes a channel 216 to let the client 108 know on which channel it will be listening. The client 108 transmits a channel command 218 to let the Media Server A know to which channel to transmit. The client is thus connected to the desired conference and may begin transmitting and receiving data, e.g., audio, video, and/or text data.

The Media Server A transmits information regarding the other participants in the conference to the client 108 via an add user command 220. This information typically includes the users' names and may also include other information as well. The names of the conference participants may then be displayed on each client's user interface, according to an embodiment of the invention. Each time a new client joins the conference, all of the other clients typically receive an add user command from the media server hosting their conference. Similarly, each time a client exits a conference, each remaining conference client typically receives a delete user command 222 which results in the removal of the deleted user's name from the user interface.

Conference XYZ exists until empty, i.e., until the last client exits, at which point, the Media Server A sends a command instructing the dispatch server 102 to delete the Conference XYZ from the conference table 300.

In the first example discussed above, the dispatch server 102 determined that the Conference XYZ existed on a particular media server and directed the client 108 to that media server (e.g., Media Server A). On the other hand, if after receiving the join request 206, the dispatch server 102 determines that conference XYZ does not currently exist in the conference table 300, the dispatch server 102 may review a capacity table (e.g., the capacity table 301 shown in FIG. 3B) to identify the media server 104 having the greatest available capacity for hosting a new conference. In its review of the capacity table 301, the dispatch server 102 may first determine which media servers are in service, then determine which media servers of those in service have the appropriate capability(ies) before determining whether the dispatch server 102 is presently in contact with the media. The dispatch server 102 may occasionally lose contact with a media server. This situation may not necessarily indicate a problem with the media server, but the dispatch server 102 should not generally send clients to media servers whose communications abilities may have become disrupted. When the dispatch server 102 has narrowed the list of media servers down to those media servers who are in service, have the appropriate capabilities, and are in communication, then the dispatch server 102 determines which of those servers has the greatest unused capacity. For example, examination of the capacity table 301 indicates that Media Server A has the greatest unused capacity of those media servers in the capacity table 301 that are in service, have telephony and text capabilities, and are presently in communication with the dispatch server 102. On the other hand, if the conference requires video capability, then Media Server C would be the appropriate server for the conference request.

Having identified an appropriate media server, the dispatch server 102 will then direct the client 108 to the identified media server 104 and send the reserve command 207 to the identified media server (e.g., Media Server A). When the dispatch server 102 receives the user joined command 215 from the Media Server, the dispatch server 102 will create an entry for the Conference XYZ in the conference table 300, assuming that the entry does not already exist.

Thus, the dispatch server selects an appropriate media server to host a client-requested conference on the basis of various characteristics of the available media servers. The client 108 typically assumes no control over the dispatch server's selection of a media server, beyond identifying the conference requested. Thus, the client is not generally part of the decision process involved in selecting a server to host the conference. This approach may optimize the usage of the NOC's resources since the clients typically need to communicate with a particular conference with no concern or interest regarding which media server hosts the conference.

Once the dispatch server 102 has selected a media server (e.g., the Media Server A shown in the capacity chart 301 of FIG. 3B), then the dispatch server 102 sends the reserve command 207, as discussed above. When the media server 104 receives a reserve command 207 for a conference not already in progress, then the media server 104 may be configured to instantiate a new conference. Of course, the media server 104 could also wait to undertake this action until after receiving a communication (e.g., the join request 213) from the client 108. In any event, the identified media server will create the conference XYZ if it does not already exist. The dispatch server 102 then dispatches the client 108 to conference XYZ on the identified media server in the manner described above.

While the capacity table 301 reports each media server's capacity in terms of unused capacity, the media servers' respective capacities could be reported in other terms, such as percentage of unused capacity. Moreover, capacity need not be reported in terms of a percent but could just as easily be reported in another format. Of course, some media servers may not have the same capacities for hosting conferences as other media servers. Thus, measuring unused capacity may be simpler than measuring used capacity (e.g., percentage used) since different media servers may have different upper bounds on their capacities. In some embodiments of the invention, the dispatch server 102 need not consider the type of the conference requested, such as when all the media servers have identical capabilities. Similarly, the dispatch server 102 may also need to consider planned out-of-service periods for the various media servers (e.g., planned maintenance, unavailability for contractual reasons, etc.), according to an embodiment of the invention.

The available capacity of a media server may be estimated in a variety of ways, according to various embodiments of the invention. For example, in one embodiment, the dispatch server 102 may estimate a given media server's available capacity by the bandwidth allocated to a particular channel type, e.g., video or audio. By contrast, for a configuration having only one type of channel, e.g., audio, the dispatch server 102 may only need to keep track of the number of users currently on a given media server. Capacity may also be measured in terms of CPU units or bandwidth units. As a general matter, capacity estimations may be modified or made more sophisticated over time without having to make major architectural changes to the NOC 100. According to another embodiment, the dispatch server 102 measures capacity by the number of conferences on a media server multiplied by some predetermined number of users. This mechanism may be used to effectively reserve conference capacity according to a customer's wishes. For example, a customer Internet Service Provider (“ISP”) may enter into a contractual arrangement with the NOC 100 according to which any conference associated with that ISP is allocated the bandwidth resources to support the predetermined number of clients. Thus, even where fewer than the predetermined number of clients are participating in a given conference on a media server, the dispatch server 102 will estimate the media server's as if the predetermined number of clients were participating in the conference. This approach generally guarantees to the customer ISP that at least that number of clients will be able to participate in the conference.

The dispatch server 102 may perform functions other than selecting conferences for clients 108. For example, the dispatch server 102 may include software configured to dynamically recreate conferences in the event that a media server hosting the conference goes down. That is, in such a situation, the users in a particular conference may be dispatched to another media server for re-creation of the conference. The dispatch server 102 may also be used to implement features useful to the ISP customer. For example, if a user is talking to a sales representative at an e-commerce web site and wants to talk to the manager, the dispatch mechanism may be employed to effect dispatch of the user to the manager. As an ordinary artisan will understand, there are a wide variety of functions that may be derived from this powerful mechanism which are contained within the scope of the present invention.

Embodiments of the invention may be conceptualized as creating numerous small conferences, e.g., each beginning with one client. As clients are added to a particular conference, the conference fills. Because of this, there is a risk that the conferences on any single media server 104 could accumulate so many users that the server's capacity is exceeded and data begins to get dropped. To address this possibility, an embodiment of the invention enables the media server 104 to notify the dispatch server 102 when it needs to “punt” one or more of its conferences due to a variety of conditions, such as the media server going off line or current traffic exceeding the server's capacity. In such cases, the dispatch mechanism of the present invention may reconstruct the punted conference, or conferences, on one of the other media servers with little or no noticeable latency. That is, the original media server dispatches the clients of the punted conference either back to the dispatch server or to a new media server on which the conference will be reconstructed. In other words, the dispatch server 102 may determine where the conference should be reconstructed and communicate the IP address of the new media server to the original media server (or directly to the clients) so that the participant clients may be dispatched to the new media server directly. Alternatively, the media server itself may have a default media server whose IP address it communicates to the clients, e.g., a pre-determined backup server. When the clients 108 receive any type of dispatch, they typically hang up and call the server to whom they have been directed, and upon doing so, their conference may be reconstructed. Thus, the client 108 is relatively stateless, e.g., a client could be in one media server for half an hour, get dispatched and end up in another media server for the remainder of the conference, all of this being transparent to the end user.

FIG. 4 illustrates an embodiment of the invention in which the NOC 100 has been expanded to include an authentication server 106 and a standby dispatch server 110. The authentication server 106 provides an additional level of security by validating incoming requests from clients 108 to participate in conferences on the NOC 100. As discussed above, the dispatch server 102 may be configured to perform the functions of the authentication server 106, but performance and security may be enhanced, at least in some embodiments of the invention, by having one or more separate severs perform the client authentication tasks. In like manner, having one or more separate servers configured for dispatching tasks may also provide a more robust system than one whose operations depend upon a single dispatch server.

In this embodiment of the invention, the dispatch server 102 may communicate with the authentication server 106, the standby server 110, and the various media servers 104 via a switch 107. The switch 107 may be deployed in configurations other than that shown in FIG. 4, and the authentication server 106 may be deployed without the standby server 110, and vice versa.

The customer web page 112 provides the client 108 with the IP address of the authentication server 106 and an account number or authentication code which is used for authentication purposes. Using the IP address obtained from the web site 112, the client 108 contacts authentication server 106 requesting to join conference XYZ. The authentication server 106 receives the join request from client 108 via port 3450 and, upon validation of the request, dispatches client 108 to the dispatch server 102 by providing its IP address to the client. Validation of the client request may be accomplished by comparison of the account number or authentication code accompanying the request with a list of valid accounts accessible to authentication server 106. Alternatively, the request may be preceded by a communication from the customer web site 112 alerting the authentication server 106 of the impending request and providing authentication information. The dispatching software on the dispatch server 102 may provide a further security layer, according to an embodiment of the invention. In this embodiment, when one server (e.g., the dispatch server 102) dispatches a client to another server (e.g., a media server 102), the first server then calls the second which places the client on a “will call” list. The second sever then rejects any calls from entities not on its will call list. Communications between the client 108 and the NOC 100 may otherwise proceed in the manner previously described in FIGS. 1-3.

The second, or standby dispatch server 110 may be provided to replace the dispatch server 102 in the event that the dispatch server 102 enters an inactive state, whether planned or unplanned, according to an embodiment of the invention. The standby dispatch server 110 may monitor the health of the dispatch server 102 and may include software configured to detect failures on the application as well as the hardware level of the dispatch server 102.

The active dispatch server(s) 102 typically provide(s) the dispatch mechanism of the present invention. As discussed in FIG. 1, the application registry server 120 typically registers all active servers, including both media servers 104 and dispatch servers 102. According to an embodiment of the invention, a standby dispatch server 110 may include a standby service module 401 that monitors the status of the dispatch application on the dispatch server 102 by periodically querying the application registry server 120 to determine if the application registry server 120 still considers the dispatch server 102 to be active. For example, the standby service module 401 may use an ultra-light Java Remote Method Invocation (“RMI”) call to the application registry server 120 in monitoring the dispatch server 102. The standby server 110 may also monitor the status of any of a variety of machines associated with the NOC 100. These machines may include, for example, a default gateway, any of the media servers, the application registry server, and an administrative server (i.e., an auxiliary server for performing administrative functions). Of course, the standby server 110 may operate in conjunction with the application registry server 120, and in some embodiments, the standby server 110 may even reside on the same machine as the application registry server 120.

An ordinary artisan will recognize that an embodiment of the invention may comprise a plurality of dispatch servers, all of whom are active, and none of whom have been specifically designated as a standby server. In such an embodiment, should one of the dispatch servers fail to operate, then the application registry server 120 can direct one of the other dispatch servers to assume operations of the troubled dispatch server. A system administrator may be informed of the failure and switch over using an alert-page or some other integrated solution.

According to various embodiments, the authentication server 106 may itself be made redundant in a manner similar to that described above with reference to dispatch server 102. Thus, an inactive standby authentication server may be provided to take over the authentication function if authentication server 106 ever goes down.

Similarly, when a media server 104 experiences difficulties, the dispatch server 102 is often the first to know because it constantly communicates with the media servers. As described above, the dispatch server 102 typically does nothing out of the ordinary when it determines that a media server is going off line except to make the appropriate alteration to its media server list, such as that indicated by the conference chart 300. That is, the dispatch server 102 allows the conferences on the downed media server 104 either to be dispatched by that server as it's going down, or to be reestablished according to the original procedure, i.e., the clients reestablish contact with the system and recreate the conference on another media server.

Embodiments of the invention may also provide system management tools that proactively handle such server crashes. For example, out-of-band signaling between machines can alert system management to problems with servers. Some alternative embodiments may provide quality-of-service tools that continuously collect latency data for all of the media servers in the NOC 100. If the latency data indicate that a particular server requires more or less CPU than originally anticipated, adjustments to that server's capacity may be made.

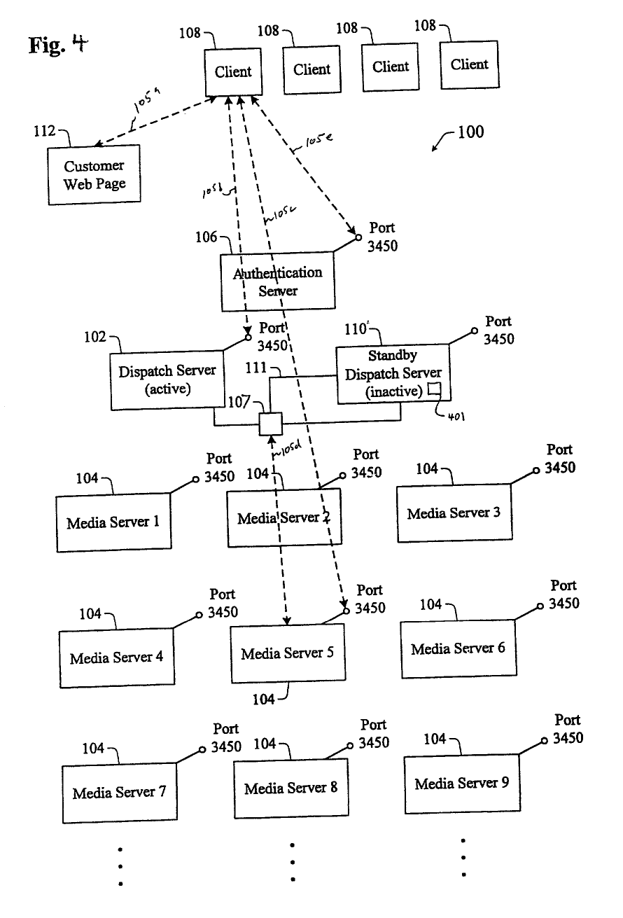

FIG. 5 illustrates an embodiment of the invention having multiple active dispatch servers 102a-102c configured to dispatch client communication requests in parallel, according to an embodiment of the invention. Each dispatch server 102a-102c typically maintains its own conference table 300 and its own capacity table 301, according to an embodiment of the invention. A dispatcher switch 501 receives incoming connect requests (e.g., the connect request 202), whether directly from clients or from an intermediary, such as the authentication server 106, and selects a dispatch server to receive the connect request. The dispatcher switch 501 may select a dispatch server from the dispatch servers in a round-robin fashion, according to an embodiment of the invention. For example, the dispatcher switch 501 may be set to select the dispatch server 102a when it next receives a client connect request. Accordingly, upon the arrival of a connect request, the dispatcher switch 501 passes the connect request to the dispatch server 102a and then advances to the next dispatch server on its list of active dispatch servers, e.g., the dispatch server 102b. Of course, the dispatcher switch 501 may include a sophisticated selection mechanism that may even resemble the selection mechanism described above for selecting a media server based on its available capacity, according to an embodiment of the invention.

The dispatch servers 102a-102c communicate media server conference and capacity information to each other since each dispatch server may independently create a conference and/or receive information from a media server regarding acceptance of a client. The dispatch servers may multicast conference creation data to the other dispatch servers, according to an embodiment of the invention. Likewise, the media servers may multicast client acceptance information, according to an embodiment of the invention. The NOC 100 may also include (e.g., in one of the dispatch servers) a call resolution module 504 to correct those situations in which two or more conferences are created when only one should exist. This situation may arise when multiple clients contact the NOC 100 to access a presently non-existent conference (e.g., “conference XYZ”) and at least some of these conference requests are processed by other dispatch servers before the dispatch server that first created the conference is able to communicate its existence to the other dispatch servers. The call resolution module 504 may simply roll the clients into one conference and delete the other conferences using the procedure described above for creating and managing conferences.

The dispatch servers 102a-102c shown in FIG. 5 each maintain their own conference tables 300a-300c and capacity tables 301a-301c. Of course, the NOC 100 may maintain consolidated conference tables and consolidated capacity tables that each dispatch server accesses in processing client communications. The NOC 100 of this embodiment may provide improved communications processing, depending on the particular hardware/software configuration of the NOC 100.

The application registry server 120 may provide the call resolution module 504, according to an embodiment of the invention. Likewise, the application registry server 120 may also multicast media server conference and capacity information to the dispatch servers, according to an embodiment of the invention.

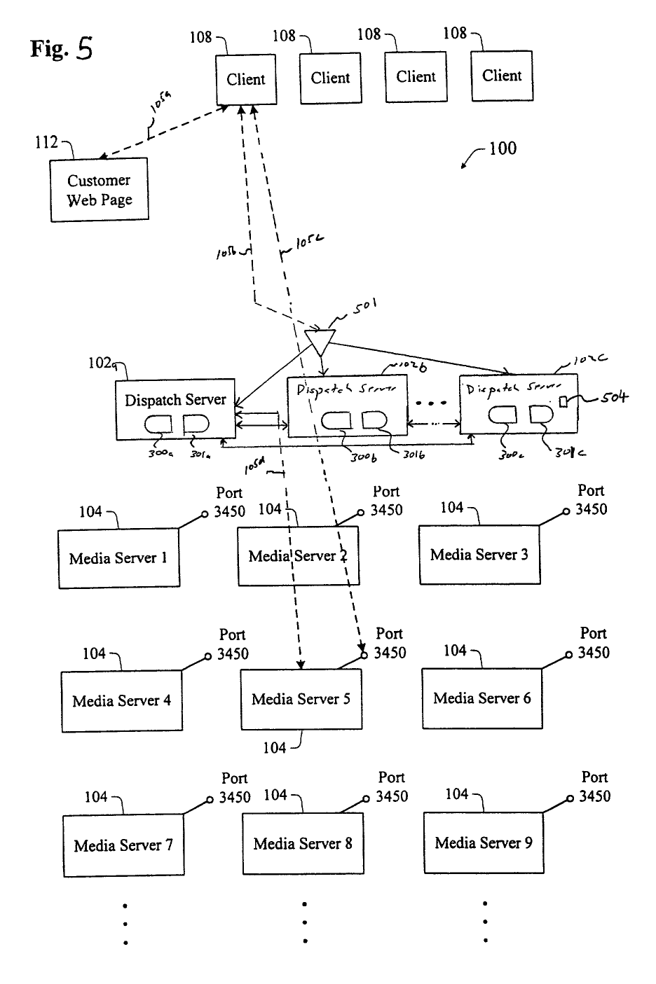

FIG. 6 illustrates a capacity table 601, according to an alternative embodiment of the invention. As previously discussed, the dispatch servers may select media servers using additional information than that provided by the capacity table 300. Various media servers may even be tuned for particular conference media types, such as text, voice, and/or video. In such an embodiment, the dispatch server may select a media server based upon more data than just the media server's available capacity. For example, a dispatch server may select Media Server A, tuned only for voice and text, as shown in the capacity table 601, over Media Server C, tuned for voice, text, and video, even though Media Server A has less available capacity than Media Server C. The dispatch server's rationale for selecting Media Server A is that the ability to provide video communications should be carefully rationed since not all servers may support this type of communications. Of course, the capacity table 601 may include other data regarding the media servers, and the dispatch servers may use even more sophisticated approaches in selecting a media server for a new conference.

FIGS. 7-9 provide simplified block diagrams of the software configurations employed in the authentication server 106, the dispatch server 102, and the media server 104, respectively, according to an embodiment of the invention. The authentication server 106, the dispatch server 102, and the media server 104 may be based upon the same general software architecture. The main difference between these servers is their installed service class modules. That is, a generic server object 700 may provide the basis for the dispatch server 102, the media server 104, and the authentication server 106. According to an embodiment of the invention, the generic server object 700 may comprise Java-based server software running on an NT operating system. The generic server object 700 may employ the NT server model in that services are installed on top of the server object 700 which have start, stop, pause, and resume interfaces with server object 700. The generic server object 700 on each of the different types of servers may have access to a system memory 701 configured to store a list of the services employed by that server type.

The generic server object 700 provides basic application services, such as configuration, logging, tracing, startup, orderly shutdown, and remote access. The generic server object 700 may also run service modules that perform application functionality. Many service modules may be used in multiple and different applications, as they, too, may be built for general purposes and reuseability. Re-using the same code in multiple applications often renders software more robust and maintainable.

The generic server object 700 may employ an object-oriented event model based on the model used in the Java user-interface system. Objects in that system typically have incoming methods and fire outgoing events. The events are multicast so that multiple objects can subscribe to another object's events. Every object that fires events typically offers “add listener” and “remove listener” methods for that event. A “Remote Event” nests other events. This allows other processes or machines on the network to listen for events remotely.

The generic server object 700 typically loads and manages a configuration file on startup that can be accessed by any service run by the server. From this configuration file, the server object 700 loads the class names of the services it is to run. This process determines the server application that will be executed by the machine hosting the server object 700. It provides methods to set and get configuration properties, and creates and starts the services it finds in the configuration file. The server object 700 fires events when a configuration variable is changed, and when a new service is created. This has the advantage that the server's configuration may be changed dynamically without the necessity for rebooting.

The service modules running on server 700 are typically based upon a single service class. The generic service class provides remote access, convenient access to the base server object, and full support for tracing and event logging. The basic service fires trace events and log events. Each service has a published interface accessible remotely via Java's Remote Method Invocation (“RMI”) mechanism, according to an embodiment of the invention. The interface includes an incoming interface for receiving methods and an outgoing interface for firing events. The RMI mechanism provides system flexibility in that it allows any of the service modules to exist across machines.

A remote-server service module 702 facilitates remote access to the server via the RMI mechanism. The remote-server service module 702 allows remote programs to restart, stop, query, and configure the server object 700. The remote-server service module 702 provides the remote interfaces to the server object 700 by which remote configuration may be achieved. The remote-server service module 702 also provides version information to remote applications.

A logger service module 720 in the server object 700 provides a simple mechanism to log text information. The logger service module 720 can be configured to log to a file, to the console, both, or neither. It may run a separate output thread to buffer file output for increased performance under high-stress conditions.

A trace logger service module 721 in the server object 700 inherits the logger service module 720. When the trace logger service module 721 is started, it listens for “service added” events from the generic server object 700. For every event, it listens for the new service's trace events. In effect, it listens for all trace events that happen in the system, and logs them to a file or the console, as configured.

An event logger service module 722 in the server object 700 behaves like the trace logger service module 721, subscribing for all log events in the system. These can be reported to a file or to the console, as configured.

A client host service module 704 provides a call control service that facilitates the connection to clients. This service module isolates the protocol between the client and the server, providing methods and events that correspond with connection and other protocol-related tasks. The client host service module 704 creates remote user objects that represent currently connected clients. It fires connection, disconnection, text message, ignore, and other events. Each remote user object typically provides remotely-accessible methods to send text messages, disconnect, add and remove users from the roster, and place requests for channels to be opened up with a given media type.

The authentication server 106 may include a validation service module 706 which performs the function of authenticating or validating an incoming request, triggering dispatch of the join request if valid, or rejection of the request if invalid. According to an embodiment of the invention, validation may be determined with respect to account numbers or codes identifying traffic from customer web pages which may be stored in the system memory, or received from the customer web page immediately in advance of incoming request.

Dispatch service module 802 may perform the primary functions of dispatch server 102. For example, the dispatch service module 802 may maintain a list of the media servers 104 configured for receiving conference requests and may communicate with a dispatchee service module 902 on those machines. As previously discussed, the dispatch server 102 obtains a list of available media servers from the application registry server 120. The dispatch service module 802 may process calls from a call control service, such as that provided by the client host service module 704. As discussed above, if a conference requested by a client does not exist on any of the connected media servers, it is typically created on the media server with the most unused capacity. The call is then dispatched to the server on which the conference was created. The dispatch service module 802 may also determine the available capacity of the media servers, according to an embodiment of the invention.

The dispatches service module 902 is a counterpart to the dispatch service module 802 and typically resides on the media servers 104. The dispatchee service module 902 listens for commands from the dispatch service module 802 and passes them on to the appropriate service. If the media server is shut down or experiences a fatal exception, the dispatchee service module 902 notifies the application registry server 120 that it is shutting down. According to an embodiment of the invention, in the event of a shut down of a media server, the corresponding dispatches service module 902 dispatches all connected clients to dispatch service module 802 for recreation of their respective conferences on another server.

The dispatch service module 802 and the dispatchee service module 902 are typically complementary services that cooperate across machine boundaries and together effect a dispatch mechanism, according to an embodiment of the invention. As mentioned above, the dispatch service module 802 typically runs on a dispatch server, while the dispatches service module 902 typically runs on a media server. It should be noted, however, that a dispatch server may run the dispatchee service module 902 as well. The dispatch service module 802 dispatches clients to the media servers and triggers conference creation on the media servers. The dispatches service module 902 creates conferences in response to a command from a dispatch server, and adds or deletes users from the conferences. The dispatchee service module 902 may also trigger creation of mesh components (described below) corresponding to new conferences and new users through the groups service as will be described, according to an embodiment of the invention. The dispatchee service module 902 may also determine its media server's current available capacity and report this available capacity to the active dispatch server (e.g., by multicast to those dispatch servers who have registered with the application registry server 120), according to an embodiment of the invention.

Because additional dispatch servers may be activated in the NOC 100 at various times, the dispatches service module 902 may periodically query the application registry server 120 for a list of active dispatch servers. The dispatchee service module 902 may multicast information to all registered dispatch servers.

The dispatches service module 902 may also store a time stamp for each client corresponding to the time when the client joined a conference. When the client leaves the conference, this information is fired out as an event which may be stored in a log file. This information may be used, for example, to generate usage reports or billing information for customers.

An embodiment of the dispatch mechanism will now be described in greater detail with reference to FIGS. 7-9. Each of the servers 102, 104, and 106 has a client host service module 704 which listens on port 3450 and facilitates communication with the clients 108. That is, the client host service module 704 on each server is a generic object that facilitates the connection between a client and the server. The client host service module 704 manages the client from the server's point of view, i.e., it abstracts the client connection protocol from the server. The client may speak a simple TCP text protocol, e.g., tabs delineating parameters with the end of the line delineating commands. While an embodiment of the invention has been described with reference to port 3450, an ordinary artisan will understand that different ports may be used to facilitate communication with clients. For example, a port which is open in most firewalls by default would be an excellent candidate.

Operation of the client host service module 704 may proceed as follows. When the client is given an IP address to call, e.g., by the customer web page (the IP address could be an authentication server, dispatch server, or a media server), the client places a call to port 3450 of the IP address transmitting a connect request, such as the connect request 202 discussed above with reference to FIG. 2. The client host service module 704 then transmits a “connect” command which confirms to the client that it has found the correct server. The client sends a “join” request with various associated parameters, such as the conference name and the referring web server IP address. This information may be determined programmatically from an account number corresponding to the customer and reported by the client's browser. (Of course, the client program need not require a browser, e.g., the client may be enhanced to provide a programming interface so that other programs operate through the client.) In any event, this procedure may be difficult to spoof, thus providing a layer of security. Additional security is also likely be provided at the customer site, e.g., restricting access to the web page. Other parameters sent with the join request may include information regarding the client's sound card, operating system, browser, application, client version, driver version on sound card, etc.

If the server is the dispatch server 102, the dispatch service module 802 may then determine to which media server the client should be directed, the client host module 704 may then issue a dispatch command instructing the client to connect with a particular media server. At this point the client starts the process over with the media server, e.g., connect request, join request, connection, etc.

If the server is a media server 104, the client host module 704 sends a channel request to the client and the client sends a channel request to the media server. With these two commands, the client and the media server may essentially negotiate the ability to send a particular kind of data, e.g., audio, on a given channel. The channel command from the client host lets the client know that it has found a location for its conference and that it can open a channel for a specific type of media on a given port. Other processes in client host 704 include add user, delete user, and keeping an up-to-date list of users in a given conference.

The client host service module 704 may be a generic object that does not effect the actual connection, conference creation, etc. In response to the various inputs, the client host service module 704 typically only fires events and issues five commands, i.e., connect, dispatch, channel, add user, delete user. For example, in response to receiving the connect request from the client, the client host service fires the event “New User” with all of the appropriate client information supplied by the client. In response to a join request from the client, client host service module 704 fires of the event “Join Request” with its associated elements. In response to the events fired by client host, and depending upon which type of server receives the call, either the dispatch or the dispatchee calls the appropriate methods, e.g., accept join, reject join, dispatch.

The server architecture of the present invention may likewise comprise an extremely flexible plug-and-play architecture in that a subset of the available service classes may be used to create a new kind of server. For example, a text chat server could be configured using the remote server service module, the client host service module, the groups service module, and a mesh service module which pipes text rather than audio data.

In addition to dispatches service module 902 and client host service module 704, a media server 104 may also include a connect service module 904 and a mesh service module 906. The connect and mesh service modules are typically media server specific entities which work closely together. The mesh service module 906 pipes various media data (e.g., audio and video), and the connect service module 904 configures the mesh according to a selected connectivity scheme. For example, in one group conference embodiment, the connect service module 904 comprises a groups service module which organizes clients into groups and configures the mesh to facilitate conferences among the members of each group.

The connect service module 904, when operating as a groups service module, registers with the corresponding client host service module 704 on the same media server requesting all of its events. The groups service module calls accept or reject when a join event is fired, dispatch when, for example, the server is shutting down, or creates a conference. When the groups service module receives calls regarding a new channel, it calls mesh service module 906 to set the channel up. The groups service module 904 may be thought of as a special case of a more generic “connect” service. That is, mesh service 906 may be configured in a wide variety of ways, e.g., group conferences, arenas, etc. The groups service may thus be replaced by some other connect service to configure the mesh appropriately for the corresponding application. The manner in which the group service module configures the mesh service will be described in greater detail in the discussion of the mesh service.

Each of the service modules are typically “agnostic” in that they look “down” but not “up,” according to an embodiment of the invention. That is, they know about the services below them from which they receive events and to which they issue method calls, but they do not generally know about the services above them to which they fire events and from which they receive method calls. For example, the connect service module 904 knows about the mesh service module 906, but the mesh service module 806 does not know (or need to know) about the connect service module 904. Thus, if it becomes desirable to organize clients into an “arena” with rows, a podium, etc., the connect service module 904 (operating as a group service module) may be replaced by an arena service module having a similar relationship with the mesh and client host service modules as does the connect service module 904. And, because neither the mesh service module 906 nor the client host service module 704 know anything about the groups service modules, this can be done without modification to the other services.

The mesh service module 906 may provide media routing components that can be connected to create various applications. The mesh service module 906 typically establishes no connections itself but instead runs the connections set up by other services. The mesh service module 906 receives incoming data streams from clients and transmits outgoing data streams to clients. The mesh service module 906 may be configured or “wired” in a wide variety of ways to implement specific types of communication. That is, the mesh service module 906 may be generic to the various embodiments of the invention (group conferencing, arenas etc.). In each such embodiment, the mesh service module 906 is typically configured by another controlling service. For example, connect service module 904 may configure the mesh service module 906 for audio or video conferencing. By contrast, an arena service module may replace the connect service module (operating as a groups service module) and configure the mesh for an arena embodiment. Alternatively, a point-to-point service may be used in place of either the groups or arena services to effect point-to-point communication. It will be understood that there are a wide variety of ways in which the mesh service module may be configured to provide a desired connectivity and a corresponding connect service for each, and that each such connect service and mesh configuration is within the scope of the present invention.

The mesh service module 906 may be likened to a generic traffic routing system which allows clients in a group to hear more than one member of the group at a time and to hear other group members even while they are speaking. The mesh service module is flexible enough to also allow for selection of individual streams for dominance or for silencing.

Therefore, each media server which handles audio typically listens for audio data on a specific port, e.g., User Datagram Protocol (“UDP”) and transforms Real Time Protocol (“RTP”) packets to smaller units of data, typically the fundamental unit of data in the mesh. An RTP packet is composed of a header and data. The header includes a time stamp (which indicates the time packet was transmitted), a source ID (used to identify client), and a sequence number (for identification of missing packets). The media servers may use Transmission Control Protocol (“TCP”) port 3450 for sending control information.

This embodiment of the invention uses RTP to transmit audio data packets because RTP typically runs on top of UDP/IP rather than TCP/IP. UDP differs from TCP in that packets are not guaranteed to be delivered. Since a voice packet is only used if it arrives in time to be played, this is preferable to TCP, which keeps re-transmitting packets until they are delivered. In addition, UDP is a socketless connection, so a single port on the server handles all clients. This typically simplifies firewall issues. Of course, it will be understood that a wide variety of communication protocols are adaptable to the principles of the present invention.

RTP packets contain information on sequence and playtime, allowing an endpoint to know what may have been missed and to know when a packet arrives too late to be played. If packets start arriving late, both the client and the media server typically increase the depth of their buffers, adaptively trading latency to insure minimal packet loss. If conditions improve, the buffers are dynamically reduced to decrease latency.

It takes time for packets to leave a client and travel across the Internet to their destination. In a voice application, this translates into a delay between the time the voice is spoken and the time it is heard on the other end. This delay is called latency. Studies have shown that in two-way conversation, if latency exceeds 500 ms, participants start having difficulty maintaining the conversation, and resort to signaling each other when they are finished speaking.

There is latency induced in both the client and server software processing. This is necessary, but can be tuned to minimize the delay and still get good server performance. The biggest variable in latency is the Internet itself. Clients communicate only with the media server, so the latency between the client and the media server is the essential factor.

Eliminating latency for Internet voice communications involves fine tuning the Internet or “bending the Internet itself to your will.” One way to make this possible is to use centralized servers, so at least one endpoint is fixed. This endpoint needs to be extremely well connected to all ends of the Internet, and needs to be on a network that has minimal end-to-end latency. The idea is for the latency to be deterministic (that is, stay on a homogenous network) for as much of the trip as possible. As latency problems are identified, they can be addressed by instituting peering relationships between the network hosting the server and the network experiencing problems. For example, breaking up packets into smaller portions typically reduces the average latency per unit of data for high speed clients because of the ability to buffer smaller chunks of data.

When notified of a new conference, the connect service module 904 triggers creation by the mesh service module 906 of a corresponding sorter object and the appropriate interconnections. For each new client added to a conference, the connect service module 904 triggers creation by the mesh service module 906 of all of the corresponding mesh objects (i.e., the scheduler, filter, and sender objects) and their interconnections. The calls for creation and release of the objects and connections in the mesh are queued in the groups service and sent to the mesh service between clock transitions.

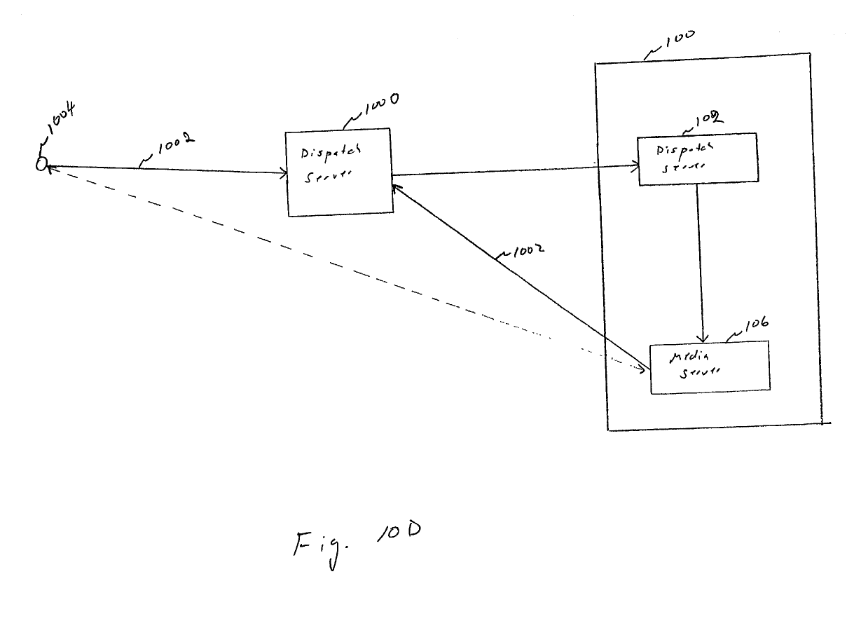

FIGS. 10A-10D illustrate an embodiment of the dispatch server 1000 that has been configured to provide a switchboard function that dispatches incoming communications requests by connecting a client 108, or a customer, to its destination over the public switched telephone network 1002. As shown in FIG. 10A, the dispatch server 1000 resembles the dispatch server 102 but also includes a switchboard module 1001 that has been configured to receive incoming telephonic communications requests, such as communications requests from clients 108, contact another party, such as the NOC 100, and then perform a callback operation that connects the client 108 and the NOC 100 over the PSTN 1002, according to an embodiment of the invention.

The dispatch server 1000 may be applied to embodiments where overall system efficiency would be improved by having the clients 108 and the NOC 100 communicate over the PSTN 1002 rather than another electronic network, such as the Internet. The dispatch server 1000 may also be helpful in connecting the NOC 100 with customers who do not have access to computerized clients, such as the client 108. For example, the switchboard module 1001 may communicate with a modem (not pictured) that receives incoming customer calls, such as from a customer 1004 at a local telephone number, as shown in FIG. 10B. The switchboard module 1001 then contacts the NOC 100, perhaps located in an area code different from the customer 104. The switchboard module 1001 may even make its initial contact with the NOC 100 over an electronic network other than the PSTN 1002. In any event, when the NOC 100 calls the dispatch server 1000, the switchboard module 1001 receives the NOC's call and connects the NOC's call with the customer's call. Once the dispatch server 1000 has connected the customer's call to the NOC's call, then the dispatch server 1000 may disconnect itself from the call while the other two parties, the customer 1004 and the NOC 100 continue communicating, as shown in FIG. 10C.

Embodiments of the dispatch server 1001 may permit entities operating some NOCs to discontinue usage of expensive toll free numbers (e.g., international toll free numbers) for a variety of purposes, such as customer service. For example, a customer in France on business, but still having Internet access, could communicate to the dispatch server 102, such as via the customer web page 112 in the manner described in FIG. 1, and thereby communicate with a NOC located in the United States. Likewise, if the same customer visiting France did not have access to the Internet, the customer could telephone a local number and connect with the dispatcher server 1001. The dispatch server 1001 could then follow the procedure described above for connecting the customer with the NOC 100. In both situations, the entity associated with the NOC 100 would not need to maintain an international toll-free number. A similar embodiment could also free the entity operating the NOC 100 from having any sort of toll-free service, especially if the dispatch servers 1001 were deployed in all locations of interest to the entity operating the NOC 100. Of course, the dispatch servers 1001 could comprise functionality shared on another party's server computer, freeing the entity from having to purchase/lease dispatch servers in some/all locations.

The dispatch server 1001 may also be useful when the NOC 100 comprises geographically dispersed media servers 106, as shown in FIG. 10D. For example, a customer 1004 could telephone a local dispatch server 1000 over the PSTN 1002. The dispatch server 1000 then contacts the dispatch server 102 over an electronic network. The dispatch server 102 selects a media server 106 having available capacity that would also provide the cheapest communications over the PSTN 1002 for the entity operating the NOC 100. Specifically, a customer 1004 visiting Metz, France could telephone a local number, contacting the dispatch server 1003 housed in a local ISP. The dispatch server 1003 transmits the communication request over an electronic network to the dispatch server 102, located in the United States. The dispatch server 102 identifies a media server 106 located in Strasbourg, France that would provide the cheapest telephone connection between the NOC 100 and the customer 1004. The media server 106 telephones the dispatch server 1000 over the PSTN 1002 and identifies itself as the party to receive the customer's call, whereupon the dispatch server 1000 connects the customer 1004 with the media server 106 and then disconnects itself from the call. Of course, the customer service representative associated with the media server 106 may himself be located in the United States or even another country.

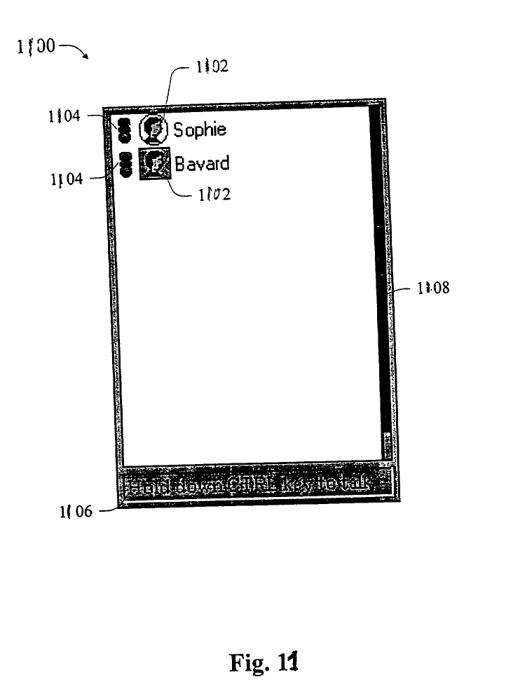

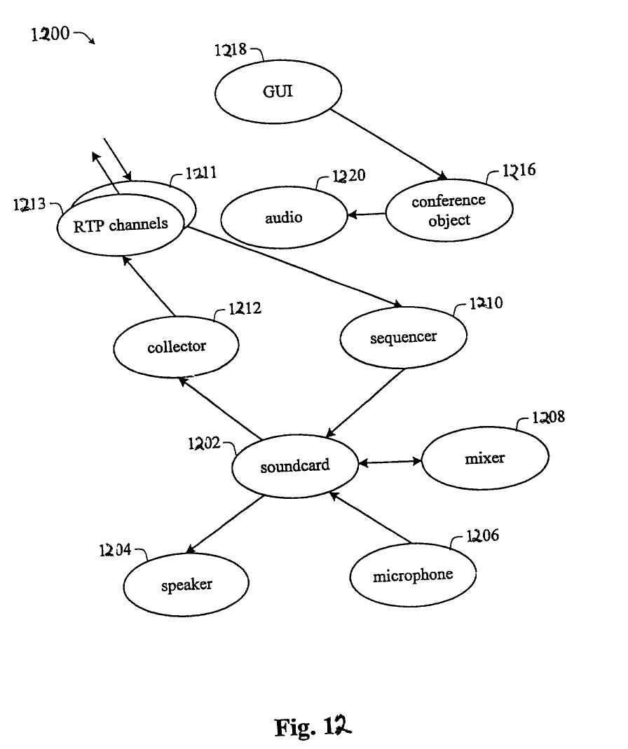

An embodiment of the client 108 for use with the group conference embodiment of the invention will now be described with reference to FIGS. 11 and 12. According to this embodiment, the user interface 1100 is a conventional Microsoft list control, such as that shown in FIG. 11 with conference member names and associated icons 1102 listed. The client's user's icon and name are typically at the top of the list, with the user's icon is highlighted, e.g., circled. When anyone else in the conference speaks, the speaker's icon may also become highlighted, e.g., background color changes, indicating that they are currently speaking.

According to an embodiment of the invention, traffic conditions may be monitored for each client (e.g., by reviewing at dropped packets) and an indicator 1104, e.g., a traffic signal, is displayed next to the client's name in the list box, representing the quality of the user's connection to the server. The display may be a traditional red-yellow-green traffic signal, or, alternatively, 1-3 green lights with more lights indicating a better connection. The interface 1100 may include a text message box 1106 at the bottom of the list window that displays messages, such as “Hold down Ctrl key to talk” or “Server disconnected”. The upper, right side of interface 1100 may display a level meter 1108 which represents the audio level of what the user is recording when she's recording, or what the user is hearing when she's listening.

The block diagram of FIG. 12 illustrates the client architecture, according to an embodiment of the invention. The client 1200 may either be an OCX (Active X Control for Microsoft's Internet Explorer) or a dynamic link library (“DLL”) (e.g., a Netscape plug-in). The size of client 1200 is relatively small (<150 k for the OCX or <230 k for the DLL). Both client types may be run by a conventional web browser, according to an embodiment of the invention. It will be understood, however, that because the client 1200 is designed as a generic plug-in, the OCX embodiment may be embedded in other applications as well. The client 1200 is also designed to allow the customer service provider to embed code into a web page which is recognized by the client's browser as an OCX object or a DLL object.

A portion of the architecture of client 1200 may comprise standard code for all applications that conform to the interfaces of Internet Explorer and/or Netscape Navigator. In addition, the client 1200 may accept a plurality of parameters from a referring customer web page, e.g., the page through which the client gains access to the NOC 100. The first parameter is typically the server address of the server that the customer wants the client to call, e.g., the dispatch server 102 or the authentication server 106 at the NOC 100. The second parameter is a user name associated with the client 1200. That is, if the referring page has the user's name already, that information is passed to the conferencing system via client 1200 and the user is not asked for his name. The third parameter is the conference name, which is how group membership is decided. The fourth parameter called Auto Join calls a join method in client 1200 when set to true (the default is true). The fifth parameter is an account number which is reported to the join command and which is used for verification purposes as described above.

An object class called Soundcard 1202 controls a speaker 1204 and records data from a microphone 1206. The soundcard 1202 may comprise standard Windows code. An object class called Mixer 1208 interfaces with Soundcard 1202 and controls the recording level and microphone input level. An object class called Sequencer 1210 provides a playback item that receives packets from RTP channel 1211 and converts them for playback by Soundcard 1202 on speaker 1204. A class called Collector 1212 comprises a recording item that collects data from Soundcard 1202 and converts the data to packets to be sent by the upstream RTP channel 1213. A Conference object 1216 communicates with the NOC's servers, e.g., the dispatch server 102 and the media servers 104. A graphical user interface (“GUI”) 1218 comprises a list control object as described above. An Audio object 1220 is used by Conference object 1216 to start and stop recording. As mentioned above, RTP channels 1211 and 1213 pass data downstream and upstream.

The control key may provide an actuator for operating the microphone, according to an embodiment of the invention. That is, according to this embodiment, the client hooks the control key across the entire operating system and uses it to control the microphone. This simple but effective mechanism is easy to learn, straightforward to operate, and generally requires far less manual dexterity than mouse-based schemes. In addition, by defaulting the client to a “normally off” microphone state, transmit bandwidth is substantially reduced and feedback caused by loudspeakers feeding into the microphone is greatly reduced. Significantly, this mechanism works regardless of any active application in the foreground.

According to an embodiment of the invention, when a user interrupts another user by pressing his control key to talk, the stream (or run) of speech of the interrupted user to the interrupting user terminates so that the interrupter does not have both his microphone and speaker active at the same time. However, any new runs by other speakers are played so that the new speaker may himself be interrupted. If the new speaker releases the control key, any of the interrupted streams still going on will resume being played to the interrupting user. This “smart duplexing” feature avoids a speaker being interrupted by his own voice (through the interrupter's microphone).

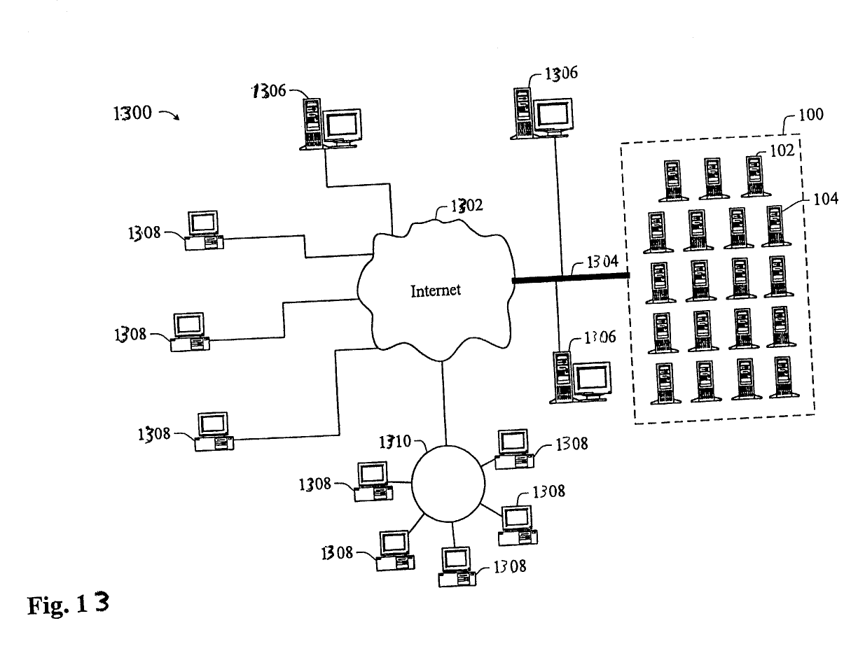

FIG. 13 provides a simplified diagram of a network environment 1300, according to an embodiment of the invention. The NOC 100 is connected to the Internet 1302 via a high bandwidth backbone 1304. The NOC 100 includes an authentication server 106, at least one dispatch server 102, and a plurality of media servers 104. The high bandwidth backbone 1304 may comprise, for example, a fiber optic data center such as that provided by Qwest Communications, Inc. of Denver, Colo. Internet sites 1306, through which clients 1308 may engage the services made possible by the present invention, are connected to the Internet 1302 as well as directly to backbone 1304. Sites 1306 may represent, for example, web sites maintained by Internet Service Providers (“ISPs”). Clients may be directly connected to the Internet as shown, or, for example, via a local or wide area network 1310.

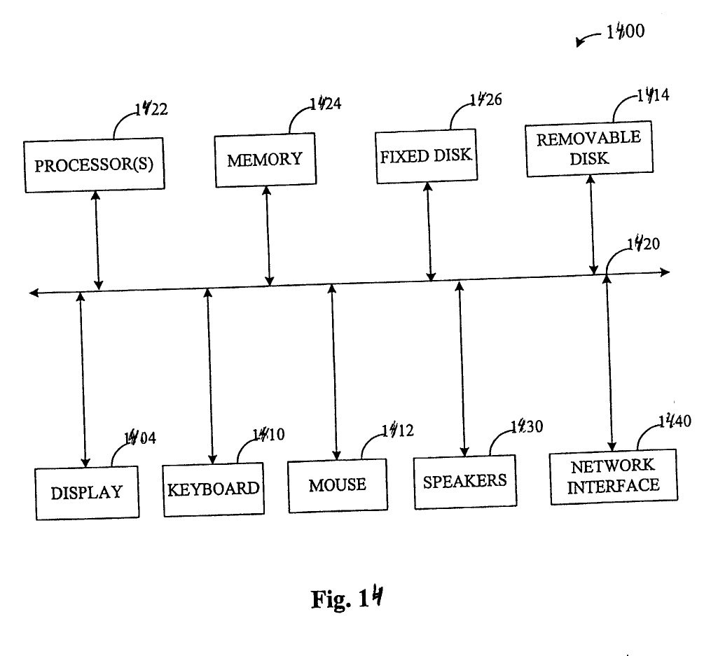

FIG. 14 is a block diagram of a generalized computer system 1400 which may be used to implement the various servers and clients described herein. Attached to system bus 1420 are a wide variety of subsystems. Processor(s) 1422 (also referred to as central processing units or CPUs) are coupled to storage devices including memory 1424. Memory 1424 includes random access memory (“RAM”) and read-only memory (“ROM”), as well as various persistent, non-persistent, and transient memory devices. An ordinary artisan will recognize that the ROM transfers data and instructions uni-directionally to the CPU, and RAM is used typically to transfer data and instructions in a bi-directional manner. Both of these types of memories may include any suitable ones of the computer-readable media described below. A fixed disk 1426 is also coupled bi-directionally to CPU 1422; it provides additional data storage capacity and may also include any of the computer-readable media described below. The fixed disk 1426 may be used to store programs, data and the like and is typically a secondary storage medium (such as a hard disk) that is slower than primary storage. An ordinary artisan will appreciate that the information retained within the fixed disk 1426, may, in appropriate cases, be incorporated in standard fashion as virtual memory in the memory 1424. Removable disk 1414 may take the form of any of the computer-readable media described below. For example, a server element (e.g., the dispatch server 102, the media server 104) may be accomplished by loading appropriate software into a memory and executing the software by the CPU 1422.

The CPU 1422 may also be coupled to a variety of input/output devices such as display 1404, keyboard 1410, mouse 1412 and speakers 1430. In general, input/output devices may be any of video displays, track balls, mice, keyboards, microphones, touch-sensitive displays, transducer card readers, magnetic or paper tape readers, tablets, styluses, voice or handwriting recognizers, biometrics readers, or other computers. The CPU 1422 optionally may be coupled to another computer or telecommunications network using a network interface 1440. With such a network interface, it is contemplated that the CPU 1422 might receive information from the network, or might output information to the network in the course of performing the above-described method steps. Furthermore, method embodiments of the present invention may execute solely upon CPU 1422 or may execute over a network such as the Internet in conjunction with a remote CPU that shares a portion of the processing.

The open architecture of the present invention avoids having to dedicate the bandwidth of specific servers to specific customer web pages or requiring the customer or the client to call up in advance to arrange a particular conference. According to the invention, conferences are created spontaneously and bandwidth is allocated dynamically. Thus, the customer web sites can create whatever conferences they want and arrange users in whatever groupings they want, being limited only by the amount of utilization capacity for which they have contracted with the NOC 100. According to an embodiment of the invention, utilization capacity is based on user capacity, i.e., a maximum number of simultaneous users, rather than dedicated resources. It will be understood that, as with electric power generation, the total capacity of the system can be overbooked in accordance with usage statistics. For example, advantage can be taken of the fact that usage peaks in Japan are complementary with those in the United States.

In this area, there are several specific problems which often confound ISPs. For example, when clients connect in conventional systems, they must often stay connected to the same server to communicate. This is obviously undesirable in situations in which the server's capacity is exceeded or in which the server goes off line. In addition, there is the logistical problem presented by the thousands and thousands of clients all over the Internet that must somehow find each other. This brings up the related issue of how to get participants in the same conference to connect to the same server at the same time.

A single server architecture can operate in the face of these problems provided the number of clients and conferences serviced by the server is limited to a relatively small number. Unfortunately, from the point of view of most ISPs, this is not an acceptable solution. A multiple server architecture can address the issues regarding the overall number of clients to be serviced, but with more than one server, the problem becomes how to determine when and where to create a particular conference, and how clients will know with which of the multiple servers to connect (i.e., the different servers have different IP addresses).

A real-time communication system designed according to the present invention may solves many of these problems. The dispatch server(s) of the present invention provide a single point(s) of contact which communicates the location of conferences to clients. Moreover, the architecture employed does not require a complex communication protocol between the dispatch and media servers.

Another scalability mechanism is also provided according to various embodiments of the invention. This scalability mechanism employs a middle layer of dispatch servers between the NOC's primary dispatch server and the farm of media servers. That is, the dispatch servers in the middle layer each have their own dedicated bank of media servers in which they create conferences, monitor media server capacity, and dispatch clients in the manner described above. The primary dispatch server remains the initial point of contact with the NOC except that, in this embodiment, the primary dispatch server is responsible only for communicating with and dispatching clients to the dispatch servers in the middle layer. Thus, if a client contacts the primary dispatch server requesting to join a particular conference, the primary dispatch server contacts the middle layer of servers to determine where the conference is located. Each of the middle layer of dispatch servers then determines if one of its media servers is facilitating the conference, and if so, reports this to the primary dispatch server which dispatches the client either to the reporting dispatch server or directly to the relevant media server if the IP address of the media server is reported to the primary dispatch server.

Embodiments of the invention may further include a help system, including a wizard that provides assistance to users, as well as technical staff responsible for configuring the network operations center and its various components.

In addition, embodiments of the present invention further relate to computer storage products with a computer-readable medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as floptical disks; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher level code that are executed by a computer using an interpreter.

While the invention has been particularly shown and described with reference to specific embodiments thereof, it will be understood by those skilled in the art that changes in the form and details of the disclosed embodiments may be made without departing from the spirit or scope of the invention. For example, embodiments of the invention have been described with reference to the object-oriented Java programming language and development tools. It will be understood, however, that the principles of the present invention may be embodied using a variety of other software paradigms including, for example, other object-oriented programming languages and tools. Moreover, merely because specific embodiments of the invention have been described with reference to communications over the Internet and/or the World Wide Web does not restrict the scope of the invention to such implementations. On the contrary, the scope of the invention encompasses a much broader interpretation of electronic networks including, for example, local area and wide area networks.

Embodiments of the invention using a cable television electronic network and/or an interactive cable television network may be developed for operation with any acceptable cable format and/or standard, as an ordinarily skilled artisan will recognize. For example, embodiments of the invention may be compatible with communications transmitted in accordance with the Advanced Television Enhancement Forum “ATVEF” specification and standards such as ATSC, DVB, OpenCable, SMPTE, PAL, SECAM, and IETF standards/specifications.

Components of the NOC, such as the dispatch server, may be configured for operation with various client protocol modules, including, H.323, SIP, proprietary modules and others. Embodiments of the invention using a wireless voice and/or data electronic network may be developed for operation with any acceptable wireless format, as an ordinarily skilled artisan will recognize. For example, embodiments of the invention may be compatible with communications transmitted in accordance with the Short Messaging Service (“SMS”) and the Wireless Application Protocol (“WAP”) specifications and standards, such as HDML, WML, CDPD, CDMA, GSM.

In describing various embodiments of the present invention, reference is made to various hardware configurations, communication protocols, and software architectures. It will be understood, however, that the present invention is much more widely applicable than the specific embodiments described herein. That is, the architecture of the present invention is not necessarily protocol or media specific and may be adapted to any protocol or any kind of media. Moreover, even though a Java implementation is described, other software architectures may be employed to implement the present invention.

Embodiments of the invention described herein may operate in conjunction with network operations centers having alternative configurations. One alternative network operations center configuration is described in the following related pending, commonly owned applications:

“Facilitating Real-Time, Multi-Point Communications over the Internet,” U.S. application Ser. No. 09/432,885 (Attorney Docket LIPSP001X1), filed Nov. 2, 1999 and also filed as a continuing prosecution application on Jan. 5, 2001, in the names of James A. Savage III and Sophie Muller, the disclosure of which is incorporated herein by this reference.

The network operations center along with its related subsystems and functions may be written for operation on any computer operating system and for operation in any computing environment. In addition, the various software employed in the network operations center may be designed using CORBA, COM+, ACTIVEX™ controls, and/or Java. As discussed above, Java applets may provide a plug-in client mechanism for use with another application on both a single computer and in a networked embodiment.

The communication systems displays, such as the sample user interface 1100, may be displayed using any application user interface techniques but will preferably utilize the “what-you-see-is-what-you-get” (“WYSIWYG”) display paradigm. One of ordinary skill in the art may easily recognize numerous alternate approaches to providing a user interface to receive the information needed to support a user's communications with the network operations center.

Under embodiments of the invention, the client using browsing software may communicate with a network operations center via Hypertext Markup Language (“HTML”) documents, Dynamic Hypertext Mark-Up Language (“DHTML”) documents, Extensible Mark-Up Language (“XML”) documents, and/or other similar formats over an electronic network, such as the World Wide Web. A client associated with the invention may use protocols such as Secure Sockets Layer (“SSL”) and Transport Layer Security (“TLS”), SNMP, TCP/IP, and UDP/IP in order to send instructions and otherwise communicate with various other components of the network operations center. The various components of the client and the network operations center may operate with protocols and languages in addition to those specifically disclosed herein. Similarly, the network operations center may be developed using an object-oriented programming methodology or using any other programming methodology that results in a computing system having equivalent functionality.

Embodiments of the invention have been discussed in terms of computer programs but is equally applicable for systems utilizing hardware that performs similar functions, such as application specific integrated circuits (“ASICs”).

An ordinary artisan should require no additional explanation in developing the methods and systems described herein but may nevertheless find some possibly helpful guidance in the preparation of these methods and systems by examining standard reference works in the relevant art.

These and other changes can be made to the invention in light of the above detailed description. In general, in the following claims, the terms used should not be construed to limit the invention to the specific embodiments disclosed in the specification and the claims, but should be construed to include all methods and systems that operate under the claims set forth hereinbelow. Accordingly, the invention is not limited by the disclosure, but instead its scope is to be determined entirely by the following claims.

What is claimed is:

1. A method for providing conference communications, comprising:
receiving at a dispatch server a join conference request from a client, wherein the join conference request identifies a conference requested by the client; and
transmitting to the client an identified media server configured to host the conference after selecting the identified media server from a plurality of media servers using data pertaining to available capacity on the plurality of media servers.

2. The method of claim 1, further comprising:
accepting at the dispatch server a connect request from the client prior to receiving the join conference request; and
transmitting a connect acknowledgment to the client, wherein the connect acknowledgment facilitates communications between the client and the dispatch server.

3. The method of claim 2, further comprising:
authenticating the client prior to transmitting the connect acknowledgment to the client.

4. The method of claim 1, further comprising:
receiving at the dispatch server a second join conference request from a second client, wherein the second join conference request identifies a specified conference requested by the second client;
examining a conference data repository to identify a selected media server assigned to host the specified conference; and
transmitting an identity of the selected media server to the second client.

5. The method of claim 1, further comprising:
receiving an indication from the identified media server that the client has joined the conference on the identified media server; and
updating capacity data for the identified media server to reflect the indication.

6. The method of claim 1, further comprising:
receiving an indication from the identified media server that the client has left the conference on the identified media server; and
updating capacity data for the identified media server to reflect the indication.

7. The method of claim 1, further comprising:
receiving an indication from the identified media server that all clients have left the conference on the identified media server; and
deleting data pertaining to the conference from a conference data repository.

8. The method of claim 1, further comprising:
receiving an indication from the identified media server that it can no longer support the conference;
identifying another media server of the plurality of media servers to host the conference; and
transmitting to the client an identity for the another media server configured to host the conference.

9. The method of claim 1, further comprising:
receiving in the identified media server a join conference request from the client; and
sending the client a channel identity from the identified media server, wherein the channel identity informs the client where the identified media server receives communications data.

10. The method of claim 9, further comprising:
receiving a client channel identity in the identified media server, wherein the client channel identity informs the identified media server where the client receives communications data.

11. The method of claim 9, further comprising:
receiving in the identified media server a second join conference request from a second client, wherein the second join conference request identifies a selected conference requested by the second client;
receiving communications data from the client by the identified media server; and
sending the received communications data from the identified media server to the second client.

12. The method of claim 1, further comprising:
receiving by a dispatcher switch a first connect request from the client, wherein the dispatcher switch has been configured to select the dispatch server from a plurality of dispatch servers to receive the first connect request.

13. The method of claim 12 wherein the dispatcher switch is configured to select a second dispatch server after receiving the first connect request, the method further comprising:
receiving by the dispatcher switch a second connect request from a second client;
directing the second connect request to the second dispatch server;
receiving by the second dispatch server a second join conference request from the second client, wherein the second join conference request identifies a selected conference requested by the second client; and
transmitting to the second client from the second dispatch server an identity of the media server hosting the conference.

14. The method of claim 12, further comprising:
examining conference creation data to determine whether the dispatch server and the second dispatch server have allowed a same conference to be created on different media servers of a plurality of media servers.

15. A method for providing a caller with conference communications, comprising:
receiving in a dispatch server a call from the caller over a telephony network; and
identifying a selected media server of a plurality of media servers to service the call, wherein the media servers of the plurality of media servers are configured to provide conference communications.

16. The method of claim 15, further comprising:
sending a signal to the selected media server to initiate a communications with the dispatch server;
receiving a communication by the dispatch server from the selected media server; and
connecting the call with the communication by the dispatch server.

17. The method of claim 16, further comprising:
receiving at a second dispatch server a join conference request from a client, wherein the join conference request identifies the conference associated with the call;
examining a conference table to identify the selected media server; and
transmitting the identity of the selected media server to the client.

18. The method of claim 16, farther comprising:
servicing the call at the selected media server.

19. A system for facilitating conference communications, comprising:
a plurality of media servers, each media server configured to provide conference communications; and
at least one dispatch server configured to identify a selected media server of the plurality of media servers having appropriate capacity for providing conference communications.

20. The system of claim 19 wherein the at least one dispatch server is configured to direct a client to the identified media server.

21. The system of claim 19 wherein the at least one dispatch server identifies the selected media server as having a greatest available capacity among the plurality of media servers.

22. The system of claim 21 wherein the at least one dispatch server disregards media servers of the plurality of media servers that have been scheduled for inactivity during a time period for conference communications for the client.

23. The system of claim 19 wherein the at least one dispatch server identifies the selected media server on the basis of media type.

24. The system of claim 19, further comprising:
an authentication server configured to authenticate client communication requests.

25. A dispatch server configured to facilitate conference communications, comprising:
a client host service module configured to receive a join conference request from a client over an electronic network, wherein the join conference request identifies a conference requested by the client; and
a dispatch service module configured to select a selected media server from a plurality of media servers to host the conference requested by the client using data pertaining to available capacity on the plurality of media servers.

26. The dispatch server of claim 25 wherein the client host service module is further configured to receive a connect request from the client over the electronic network prior to receiving the join conference request and is also configured to transmit a connect acknowledgment to the client.

27. The dispatch server of claim 25 wherein the dispatch service module is further configured to examine a conference data repository for a second client that has requested the conference and identify the media server assigned to host the conference, wherein the client host service module is further configured to transmit an identity for the selected media server to the second client.

28. The dispatch server of claim 25 wherein the dispatch service module is further configured to receive an indication from the selected media server that the client has joined the conference on the selected media server and is also configured to update capacity data for the selected media server.

29. The dispatch server of claim 25 wherein the dispatch service module is further configured to receive an indication from the selected media server that the client has left the conference on the selected media server and is also configured to update capacity data for the selected media server.

30. The dispatch server of claim 25 wherein the dispatch service module is further configured to receive an indication from the selected media server that it can no longer support the conference and is further configured to identify a second media server of the plurality of media servers to host the conference, wherein the client host service module is further configured to transmit to the client an identity for the second media server configured to host the conference.

31. A media server configured to provide conference communications to a client of a plurality of clients, wherein the client receives an address for the media server from a dispatch server that selected the media server on the basis of available capacity, comprising:
a client host service module configured to receive a join conference request from the client over an electronic network, wherein the join conference request identifies the conference requested by the client;
a connect service module configured to arrange conference transmissions for conference participants; and
a mesh service module configured to transmit media data to conference participants.

32. The media server of claim 31 wherein the client service module is configured to receive a join conference request from a second client, wherein the join conference request identifies a selected conference requested by the client, and wherein the mesh service module is configured to receive conference data from the client and transmit the received conference data to the second client.

33. The media server of claim 31, further comprising:
a dispatchee service module configured to send an indication to the dispatch server that the client has joined the conference on the media server, wherein the dispatch server updates capacity data for the media server to reflect the indication.

34. The media server of claim 31, further comprising:
a dispatchee service module configured to send an indication to the dispatch server that the client has left the conference on the media server, wherein the dispatch server updates capacity data for the media server to reflect the indication.

35. The media server of claim 31, further comprising:
a dispatchee service module configured to send an indication to the dispatch server that all clients have left the conference on the media server.

36. The media server of claim 31, further comprising:
a dispatchee service module configured to send an indication to the dispatch server that the media server can no longer support the conference.
